(19) United States
(12) Patent Application Publication
(10) Pub. No.: US 2007/0232166 A1
(43) Pub. Date: Oct. 4, 2007

(54) Water repellent-, oil repellent-and soil release-treated textile and method of treating textile

(75) Inventors: Kazunori Hayashi, Osaka (JP); Fumihiko Yamaguchi, Osaka (JP)

Correspondence Address: SUGHRUE MION, PLLC, 2100 PENNSYLVANIA AVENUE, N.W., SUITE 800, WASHINGTON, DC, 20037, US

(73) Assignee: DAIKIN INDUSTRIES, LTD., Osaka (JP)

(21) Appl. No.: 11/729,890

(22) Filed: Mar. 30, 2007

(30) Foreign Application Priority Data
Mar. 31, 2006 (JP) P2006-097106

(51) Int. Cl. B32B 27/12; B32B 27/04; B05D 5/00; B05D 1/28

(52) U.S. Cl. 442/86; 427/428.01; 427/288; 442/91; 442/92

(57) ABSTRACT

There is disclosed a textile which has a main surface consisting of a surface having an exposed water- and oil-repellent agent and a surface having an exposed soil release agent, by applying both the water- and oil-repellent agent and the soil release agent to the main surface, and which is characterized in that, in any of the square surface regions having a side length of 3,000 μm, of the main surface of the textile, the ratio A of the area of the surface having the exposed water- and oil-repellent agent is from 10 to 90%, and the ratio B of the area of the surface having the exposed soil release agent is from 90 to 10%, provided that the total of the ratios A and B is 100%. According to the present invention, there is provided a method for treating a textile to compatibly impart water- and oil-repellency and a soil release property to the textile so that the treated textile can exhibit such actions that make it hard for soil to adhere thereto and make it easy to remove the soil therefrom, without degrading the feeling of the textile, and there is also provided such a treated textile.

### BACKGROUND OF THE INVENTION

1. Technical Field

The present invention relates to a textile to which water repellency, oil repellency and soil release property are concurrently imparted, and a treatment method for obtaining such a textile.

2. Related Arts

Treatments for imparting water repellency and oil repellency to textiles have been conventionally well known. For example, a fluorine-containing water- and oil-repellent agent or a silicone-based water repellent agent is adhered to fibers, using a padding machine, and the fibers are then heated for their treatment. The resultant treated textile exhibits an effect to be hardly stained by aqueous soil and oily soil because of the imparted water- and oil-repellency. However, aqueous soil and oily soil, once adhered to the textile, tend to be hard to release by washing. In addition, the feeling of the treated textile tends to degrade, as compared with a non-treated textile.

On the other hand, soil release agents for imparting soil release properties to textiles [agents for removing soils adhered to treated textiles, called soil release or SR agents] are also well known. For example, a fluorine-containing or hydrophilic polymer type soil release agent is adhered to fibers, using a padding machine, and the fibers are then heated for their treatment. The resultant treated textile exhibits an effect to easily remove adhered aqueous soil and oily soil by washing. However, needless to say, aqueous soil and oily soil easily adhere to such a textile as compared with a water repellency- and oil repellency-imparted textile.

There are disclosed a method of compatibly blending a fluorine-containing soil release agent and a fluorine-containing unsaturated ester for use in a fluorine-containing water- and oil-repellent agent in a padding bath, in order to concurrently impart a water and oil repellency and a soil release property to a textile to thereby obtain a treated textile which is hardly stained and easily cleaned (cf. Japanese Laid-Open Patent Publication No. 60-104576); and a method of compatibly blending a fluorine-containing soil release agent and other various agents (cf. Japanese Laid-Open Patent Publication No. 11-21765). However, these blending methods suffer from the following disadvantages because their effects are produced basically by controlling relative balances between hydrophobicity and hydrophilicity: that is, to obtain a high water and oil repellency is to lower a soil release property; or to obtain a high soil release property is to lower a water and oil repellency, so that a maximum effect can not be induced, or so that the effect is insufficient to other fiber materials except for a specific fiber material.

In the meantime, the treatment methods for imparting water repellency, oil repellency and soil release properties to textiles are discussed below. Employed as such methods are usually, for example, a spraying method and a foam-contacting method in addition to the above-mentioned padding method. There are disclosed several specific treatment methods which employ printing techniques: a technique for stripe-pattern forming water repellent portions and water non-repellent portions on a textile to obtain swimming race wears having lower surface frictional resistance therefrom (cf. Japanese Laid-Open Patent Publication No. 09-49107); a technique for locating a water repellent agent a dot pattern, a linear pattern or a lattice pattern on a surface of a textile on the skin contacting side, and locating a water-absorbing agent on remainder portion of the surface of the textile to thereby improve the water-absorbing efficiency of the textile, in order to eliminate the sweaty and sticking feeling of the textile (cf. Japanese Laid-Open Utility Model Publication No. 61-111995), etc.

However, there has not yet been reported any effective treatment method for concurrently imparting a water and oil repellency and a soil release property to a textile, in order to obtain a treated textile which can compatibly exhibit the incompatible effects, that is, the effect to be hardly stained and the effect to be easily cleaned.

Lately, it has been announced regarding a C₈ Rf group-containing compound obtained by telomerization that there is possibility to produce perfluorooctanoic acid (abbreviated to “PFOA”) when a telomer is decomposed or metabolized (cf. Federal Register (FR Vol. 68, No. 73, Apr. 16, 2003 [FRL-2303-3] (http://www.epa.gov/opptintr/pfoa/pfoafr.pdf), EPA Environmental News FOR RELEASE: MONDAY Apr. 14, 2003, EPA INTENSIFIES SCIENTIFIC INVESTIGATION OF A CHEMICAL PROCESSING AID (http://www.epa.gov/opptintr/pfoa/pfoaprs.pdf) and EPA OPPT FACT SHEET, Apr. 14, 2003 (http://www.epa.gov/opptintr/pfoa/pfoafacts.pdf). The Environmental Protection Agency (or EPA) has announced that the scientific investigation of PFOA should be more intensively promoted (cf. Report by EPA, “PRELIMINARY RISK ASSESSMENT OF THE DEVELOPMENTAL TOXICITY ASSOCIATED WITH EXPOSURE TO PERFLUOROOCTANOIC ACID AND ITS SALTS” (http://www.epa.gov/opptintr/pfoa/pfoara.pdf)).

### SUMMARY OF THE INVENTION

An object of the present invention is to provide a treatment method for compatibly imparting “a water and oil repellency” and “a soil release property” to a textile without degrading the feeling of the textile, in order that the textile can exhibit the effect that a soil is hardly stained and easily released. Another object thereof is to provide such a treated textile.

The object of the present invention is achieved by a textile which has a main surface consisting of a surface having an exposed water- and oil-repellent agent and a surface having an exposed soil release agent, by applying both the water- and oil-repellent agent and the soil release agent to the main surface, characterized in that, in any of square surface regions, of the main surface of the textile, having a side length of 3,000 μm, a ratio A of the area of the surface having the exposed water- and oil-repellent agent is from 10 to 90%, and a ratio B of the area of the surface having the exposed soil release agent is from 90 to 10%, provided that the total of the ratios A and B is 100%.

The present invention provides a kit comprising a water- and oil-repellent agent and a soil release agent, for use in treating a textile.

The present invention further provides a process for manufacturing a textile, which comprises a step of padding or printing a soil release agent on the textile before or after printing a water- and oil-repellent agent on the textile, to give the textile.

The length of one side of said square region may be 1,000 μm, for example, 500 μm, particularly 100 μm, especially 50 μm. Preferably, the ratio A is from 18 to 82%, for example, from 30 to 70%, and preferably, the ratio B is from 82 to 18%, for example, from 70 to 30%.

Preferably, the water- and oil-repellent agent and the soil release agent are located with a predetermined pattern on the textile. For example, the water- and oil-repellent agent is located in a dot pattern or a lattice pattern on the textile, and the soil release agent is located on the remaining portions of the textile to thereby form the predetermine pattern on the textile. Preferably, the water- and oil-repellent agent exposed on the surface of the textile is in the shape of a dot (particularly a circular dot) or in the shape of a lattice, and the soil release agent is exposed on the remainder of the surface of the textile. The diameters of the dots or the widths of the stripes of the lattice comprising the water- and oil-repellent agent may be controlled to from 10 to 1,500 μm, for example, from 20 to 1,200 μm, particularly from 40 to 600 μm; and the distances between each of the dots or between each of the stripes of the lattice may be controlled to from 10 to 1,500 μm, for example, from 20 to 1,200 μm, particularly from 40 to 800 μm.

As the case may be, the soil release agent may be located in a dot pattern or a lattice pattern on the textile, and the water- and oil-repellent agent may be located on the remainder portions of the textile.

The predetermined pattern on the textile is obtained by two steps of treatments, that is, a treatment step using the water- and oil-repellent agent and a treatment step using the soil release agent.

To locate the water- and oil-repellent agent in the dot pattern or lattice pattern on the textile, a generally industrialized printing machine can be used to print the water- and oil-repellent agent on the textile.

To locate the soil release agent on the remainder portion of the textile, a generally industrialized printing machine can be used to print the soil release agent on the remainder portion of the textile; or a padding machine can be used to pad the soil release agent thereon.

As the order of the treatments, there may be optionally employed either the treatment with the water- and oil-repellent agent followed by the treatment with the soil release agent, or the treatment with the soil release agent followed by the treatment with the water- and oil-repellent agent.

In case of the treatment with the water- and oil-repellent agent followed by the treatment with the soil release agent, the soil release agent which is printed or padded on the textile later is repelled at the portion of the textile previously treated with the water- and oil-repellent agent, so that the water- and oil-repellent agent can be located at the uppermost surface of the textile. In case of the treatment with the soil release agent followed by the treatment with the water- and oil-repellent agent, the water- and oil-repellent agent is inevitably located at the uppermost surface of the textile. As a result, the same surface states can be obtained in both the cases.

Water droplets and oil droplets, when contacting the textile of the present invention, are repelled by the water- and oil-repellent agent located in the predetermined pattern (for example, a dot pattern or lattice pattern) on the textile, to exhibit the water- and oil-repellency. The mechanism of this phenomenon is analogous to the water droplet-repelling effect of lotus leaves. Accordingly, the water droplets and the oil droplets hardly contact the hydrophilic soil release agent, so that the textile can maintain high water- and oil-repellency. As a result, soil hardly adheres to the textile.

Aqueous soil and oily soil adsorbed onto the textile attributed to a load such as continuous use of the textile are retained in the portion of the textile on which the soil release agent is located. Since the portion on which the soil release agent is located does not have the water- and oil-repellent agent, the inherent soil release effect of the soil release agent can be exhibited, without lowering the washing efficiency during washing.

In other words, the inherent effects of the water- and oil-repellent agent and the soil release agent are compatibly exhibited, respectively, without impairing each other. Therefore, the textile can compatibly have the effect that the soil is hardly stained and easily removed.

Furthermore, the dot-pattern or lattice-pattern location of the water- and oil-repellent agent on the textile prevent the deterioration of the textile feeling, as compared with the method of adhering the water- and oil-repellent agent to fibers, followed by the heating of the fibers for treatment.

### BRIEF DESCRIPTION OF DRAWINGS

FIG. 1 shows cloth on which a water- and oil-repellent agent is dot-pattern (particularly circular dot-pattern) located, and a soil release agent is located on remainder portion of the cloth.

FIG. 2 shows cloth on which a water- and oil-repellent agent is lattice-pattern located, and a soil release agent is located on remainder portions of the cloth.

### DETAILED DESCRIPTION OF THE INVENTION

The “water- and oil-repellent agent” referred to in the present invention comprises a silicone-based or fluorine-containing water- and oil-repellent polymer as an active component. This polymer is a copolymer comprising a silicone-based monomer or a fluorine-containing monomer and a non-hydrophilic monomer copolymerizable with these monomers. On the other hand, the “soil release agent” herein referred to comprises a hydrophilic and water-soluble fluorine-containing or fluorine-free polymer as an active component. This polymer is a copolymer comprising a polymerizable hydrophilic monomer as an essential component. The “non-hydrophilic monomer” herein used is a monomer which is solely water-insoluble, while the hydrophilic monomer is a monomer which is solely water-soluble. The wording “water-insoluble” means that the solubility of the monomer in 100 g of water at 25° C. is 1 g or less, for example, 0.5 g or less. The wording “water-soluble” means that the solubility of the monomer in 100 g of water at 25° C. is 10 g or more, for example, 30 g or more.

Preferably, the water- and oil-repellent agent is a fluorine-containing water- and oil-repellent agent or a silicon-containing water- and oil-repellent agent, and preferably, the soil release agent is a fluorine-containing soil release agent or a phospholipid-containing soil release agent. The polymer constituting the water- and oil-repellent agent is preferably a copolymer which comprises a silicone-based monomer or a fluorine-containing monomer and a silicon-free and fluorine-free non-hydrophilic monomer polymerizable with the former monomer as essential components. On the other hand, the polymer constituting the soil release agent is preferably a polymer which comprises a phosphorus-free and fluorine-free containing hydrophilic monomer as an essential component. Preferably, the polymer constituting the soil release agent contains a fluorine atom (i.e., a fluorine-containing monomer).

As the water- and oil-repellent agent, the conventionally known agents for use in treatments for imparting water repellency and oil repellency to textiles can be used. These agents are commercially available in the forms of dispersions of water repellent and oil-repellent polymers such as silicone-based polymers and fluoropolymers in water or in the forms of solutions of the polymers in organic solvents. Among those, the fluorine-containing water- and oil-repellent agent is particularly preferred, since this agent can impart also oil repellency.

The silicone-based polymer to be used in the water- and oil-repellent agent (e.g., the silicone-based water- and oil-repellent agent) is a polymer having at least two siloxane groups. The molecular weight of the silicone-based polymer is generally from 1,000 to 1,000,000, particularly from 10,000 to 200,000. As the silicone-based polymer, the conventional silicone-based water- and oil-repellent agents can be used. A specific example of the commercially available silicone-based water- and oil-repellent agent is, but not limitative to, POLONCOAT N01 (silicone-based, manufactured by Shin-Etsu Chemical Co., Ltd.).

The fluoropolymer, in the water- and oil-repellent agent (i.e., the fluorine-containing water- and oil-repellent agent), is a copolymer which comprises a fluorine-containing monomer (particularly a monomer containing a fluoroalkyl group (hereinafter referred to as a Rf group)) and another monomer (particularly a fluorine-free monomer) as essential components.

Specific examples of the Rf group-containing monomer includes, but not limitative to, compounds or fluorine-containing monomers represented by the formula (1):
CH₂═C(—X)—C(═O)-A-Rf (1)
wherein X represents a hydrogen atom, a C₁-C₂₁ linear or branched alkyl group, a fluorine atom, a chlorine atom, bromine atom, an iodine atom, a group of CFX¹X² (in which each of X¹ and X² is a hydrogen atom, a fluorine atom, a chlorine atom, a bromine atom or an iodine atom), a cyano group, a C₁-C₂₁ linear or branched fluoroalkyl group, an optionally substituted or non-substituted benzyl group, or an optionally substituted or non-substituted phenyl group; A represents a group of —O—Y¹— (in which Y¹ is a C₁-C₁₀ aliphatic group, a C₆-C₁₀ aromatic group or a cycloaliphatic group, a group of —CH₂CH₂N(R¹)SO₂—(CH₂CH₂)ₐ (in which R¹ is a C₁-C₄ alkyl group, and a is 0 or 1), a group of —CH₂CH(OR¹¹)CH₂— (in which R¹¹ is a hydrogen atom or an acetyl group), or group of —(CH₂)ₙSO₂— (in which n is a number of from 1 to 10)),
or a group of —Y²—[—(CH₂)ₘ-Z-]ₚ—(CH₂)ₙ (in which Y² is —O— or —NH—; Z is —S— or —SO₂—; m is a number of 0 to 10; n is a number of 0 to 10; and p is 0 or 1); and
Rf represents a C₁-C₂₁ fluoroalkyl group.

The fluorine-containing monomer of the formula (1) constitutes a fluorine-containing repeating unit.

In the fluorine-containing monomer, the α-position (of acrylate or methacrylate) may be optionally substituted by, for example, a halogen atom. Accordingly, in the formula (1), X may be a C₂-C₂₁ linear or branched alkyl group, a fluorine atom, a chlorine atom, a bromine atom, an iodine atom, a group of CFX¹X² (in which each of X¹ and X² is a hydrogen atom, a fluorine atom, a chlorine atom, a bromine atom or iodine atom), a cyano group, a C₁-C₂₁ linear or branched fluoroalkyl group, an optionally substituted or non-substituted benzyl group, or an optionally substituted or non-substituted phenyl group.

In the formula (1), the Rf group is preferably a perfluoroalkyl group. The number of carbon atoms of the Rf group may be 1 to 6, for example, 1 to 5, particularly 1 to 4. Examples of the Rf group include —CF₃, —CF₂CF₃, —CF₂CF₂CF₃, —CF(CF₃)₂, —CF₂CF₂CF₂CF₃, —CF₂CF(CF₃)₂, —C(CF₃)₃, —(CF₂)₄CF₃, —(CF₂)₂CF (CF₃)₂, —CF₂C(CF₃)₃, —CF(CF₃)CF₂CF₂CF₃, —(CF₂)₅CF₃, —(CF₂)₃CF(CF₃)₂, —(CF₂)₄CF(CF₃)₂, —(CF₂)₇CF₃, —(CF₂)₅CF(CF₃)₂, —(CF₂)₆CF(CF₃)₂, and —(CF₂)₉CF₃.

In the formula (1), m may be, for example, a number of 2 to 10; n may be, for example, a number of 1 to 10 (particularly 2 to 5); and p is preferably 1 when Y² is —O—, or is preferably 0 when Y² is —NH—.

The following are exemplified as the fluorine-containing monomer.
CH₂═C(—X)—C(=0)-0-(CH₂)ₙ—Rf,
CH₂═C(—X)—C(=0)-0-C₆H₁₀—Rf

(in which —C₆H₁₀— is a bivalent cyclohexane group),
CH₂═C(—X)—C(=0)-0-C₆H₄—Rf

(in which —C₆H₄— is a bivalent benzene group),
CH₂═C(—X)—C(=0)-0-C₁₂H₈—Rf

(in which —C₁₂H₈— is a bivalent biphenyl group),
CH₂═C(—X)—C(=0)-0-(CH₂)ₘ—S—(CH₂)ₙ—Rf,
CH₂═C(—X)—C(=0)-0-(CH₂)ₘ—SO₂—(CH₂)ₙ—Rf, and
CH₂═C(—X)—C(=0)—NH—(CH₂)ₙ—Rf,
wherein X represents a hydrogen atom, a C₁-C₂₁ linear or branched alkyl group, a fluorine atom, a chlorine atom, a bromine atom, an iodine atom, a CFX¹X² group (in which each of X¹ and X² is a hydrogen atom, a fluorine atom or a chlorine atom), a cyano group, a C₁-C₂₁ linear or branched fluoroalkyl group, an optionally substituted or non-substituted benzyl group, or an optionally substituted or non-substituted phenyl group;
Rf represents a C₁-C₂₁, particularly C₁-C₆ fluoroalkyl group;
m is a number of 1 to 10; and
n is a number of 0 to 10.

The fluoropolymer also comprises a non-hydrophilic monomer which is generally free from a fluorine atom.

The non-hydrophilic monomer may be a non-crosslinkable monomer. The fluoropolymer may further contain a non-hydrophilic or hydrophilic, preferably non-hydrophilic crosslinkable monomer.

Preferably, the non-crosslinkable monomer is free from a fluorine atom, and has a carbon-carbon double bond. The non-crosslinkable monomer is preferably a vinyl monomer free from a fluorine atom. The non-crosslinkable monomer is generally a compound having one carbon-carbon double bond. Examples of the non-crosslinkable monomer include, but not limited to, halogenated vinyl compounds such as 3-chloro-2-hydroxypropyl(meth)acrylate, N,N-dimethylamino-ethyl (meth)acrylate, N,N-diethylaminoethyl(meth)acrylate, butadiene, chloroprene, glycidyl(meth)acrylate, derivatives of maleic acid, and vinyl chloride; ethylene; halogenated vinylidene compounds such as vinylidene chloride; vinyl alkyl ether; glycerol (meth)acrylate; styrene; acetoacetoxyethyl(meth)acrylate; alkyl (meth)acrylate; vinyl pyrrolidone; and isocyanate group-containing (meth)acrylates such as 2-isocyanate ethyl methacrylate, or (meth)acrylate thereof in which the isocyanate group is blocked with a blocking agent such as methyl ethyl ketoxime.

The non-crosslinkable monomer may be an alkyl group-containing (meth)acrylate. The number of carbon atoms in the alkyl group is 1 to 30, for example, 6 to 30, or 10 to 30. For example, the non-crosslinkable monomer may be an acrylate of the formula:
CH₂═CA¹COOA²
wherein A¹ represents a hydrogen atom or a methyl group; and A² represents an alkyl group of the formula: CₙH₂ₙ₊₁(n=1 to 30).

The fluoropolymer may contain a crosslinkable monomer. The crosslinkable monomer may be a fluorine-free compound having at least two reactive groups and/or carbon-carbon double bonds. The crosslinkable monomer may be a compound having at least two carbon-carbon double bonds, or a compound having at least one carbon-carbon double bond and at least one reactive group. Examples of the reactive group include a hydroxyl group, an epoxy group, a chloromethyl group, a blocked isocyanate, an amino group, and a carboxyl group.

Examples of the crosslinkable monomer include, but not limited to, diacetone acrylamide, (meth)acrylamide, N-methylolacrylamide, hydroxymethyl(meth)acrylate, hydroxyethyl(meth)acrylate, 3-chloro-2-hydroxypropyl (meth)acrylate, N,N-dimethylaminoethyl(meth)acrylate, N,N-diethylaminoethyl (meth)acrylate, butadiene, chloroprene, and glycidyl(meth)acrylate.

By copolymerizing with the non-crosslinkable monomer and/or the crosslinkable monomer, the resultant fluoropolymer can be improved in various properties such as water- and oil-repellency and soil resistance, cleaning resistance and washing resistance of these properties, solubility in a solvent, hardness, and feeling.

In the fluoropolymer, the amount of the non-hydrophilic monomer may be 0.1 to 250 parts by weight, for example, 1 to 150 parts by weight, particularly 3 to 100 parts by weight, per 100 parts by weight of the fluorine-containing monomer. In the fluoropolymer, the amount of the non-crosslinkable monomer may be 200 parts by weight or less, 0.1 to 100 parts by weight, for example, 0.1 to 50 parts by weight per 100 parts by weight of the fluorine-containing monomer; and the amount of the crosslinkable monomer may be 50 parts by weight or less, for example, 20 parts by weight or less, particularly 0.1 to 15 parts by weight.

The weight-average molecular weight of the fluoropolymer of the present invention may be 1,000 to 1,000,000, preferably 5,000 to 500,000, determined by gel permeation chromatography, in terms of polystyrene.

The soil release agent [i.e., an agent to be used to make it easy to remove soil adhered to a substrate, which is also called a SR (Soil release) agent] is commercially available as a dispersion of a fluorine-containing or phospholipid type hydrophilic and water-soluble polymer as a main component in water or as a solution of the polymer in an organic solvent. A fluorine-containing SR agent is particularly preferred because of its high soil release property. As the soil release agent, the conventionally known agents for use in SR treatment of textiles can be used.

The fluoropolymer to be used in the fluorine-containing soil release agent is a copolymer comprising a fluorine-containing monomer (particularly a monomer containing a fluoroalkyl group (hereinafter referred to as a Rf group)) and another monomer (particularly a fluorine-free monomer) as essential components.

Examples of the Rf group-containing monomer are not particularly limited, in so far as they are polymerizable. Examples of such a monomer are, for example, the compounds of the above-mentioned formula (1).

Preferably, the other monomer contains a hydrophilic group-containing monomer. Preferably, the hydrophilic group-containing monomer is free from a fluorine atom.

The hydrophilic group-containing monomer may be polyalkyleneglycol mono(meth)acrylate and/or polyalkyleneglycol di(meth)acrylate. The molecular weight of the hydrophilic group-containing monomer may be 100 or more, for example, 150 or more, particularly 200 or more, especially 250 to 3,000.

Preferably, the polyalkyleneglycol mono(meth)acrylate is a monomer represented the formula (2)
CH₂═CX¹C(═O)—O—(RO)ₙ—X² (2)
wherein X¹ is a hydrogen atom or a methyl group;
X² is a hydrogen atom or a C₁-C₂₂ optionally non-saturated or saturated hydrocarbon group; R is a C₂-C₆ alkylene group; and n is an integer of 2 to 90. Particularly, n may be an integer of 2 to 30, for example, 2 to 20.

The group R in the formula (2) is preferably an ethylene group.

The group R in the formula (2) may be 2 or more different alkylene groups combined. In this case, preferably, at least one of the groups R is an ethylene group. As the combination of the groups R, there can be exemplified a combination of an ethylene group and a propylene group, and a combination of an ethylene group and a butylene group. The hydrophilic group-containing monomer may a mixture of two or more hydrophilic group-containing monomers. In this case, preferably, at least one of the hydrophilic group-containing monomers is a monomer of the formula (2) in which R is an ethylene group.

Specific Examples of the hydrophilic group-containing monomer include, but not limited to, the following:
CH₂═CX¹COO—(CH₂CH₂O)ₙ—H,
CH₂═CX¹—(CH₂CH₂O)ₙ—CH₃,
CH₂═CX¹COO—(CH₂CH(CH₃)O)ₙ—H,
CH₂═CX¹COO—(CH₂CH(CH₃)O)ₙ—CH₃,
CH₂═CX¹COO—(CH₂CH₂O)₅—(CH₂CH(CH₃)O)₂—H,
CH₂═CX¹COO—(CH₂CH₂O)₅—(CH₂CH(CH₃)O)₃—CH₃,
CH₂═CX¹COO—(CH₂CH₂O)₈—(CH₂CH(CH₃)O)₆—CH₂CH(C₂H₅)C₄H₉,
CH₂═CX¹COO—(CH₂CH₂O)₂₃—OOC(CH₃)C═CH₂, and
CH₂═CX¹COO—(CH₂CH₂O)₂₀₋−(CH₂CH(CH₃)O)₅—CH₂—CH═CH₂.

The hydrophilic group-containing monomer may be a monomer having an ionic group (i.e., a cationic group or an anionic group) and a carbon-carbon double bond. Specific examples of such a monomer include 2-methacryloyloxyethyl-trimethylammonium chloride and N,N,N-trimethyl-N-(2-hydroxy-3-methacyloyloxypropyl)ammonium chloride.

In the copolymer of the soil release agent, the amount of the fluorine-containing monomer is 20 to 90% by weight, preferably 30 to 85% by weight, for example 35 to 75% by weight, based on the total weight of the fluorine-containing monomer and the hydrophilic group-containing monomer. When it is 20 to 90% by weight, the resultant soil release agent can have a high soil release property and prevent the infiltration of an oily soil.

The amount of the hydrophilic group-containing monomer is 10 to 80% by weight, preferably 15 to 60% by weight, for example 20 to 50% by weight, based on the total weight of the fluorine-containing monomer and the hydrophilic group-containing monomer. When it is 10 to 80% by weight, the resultant soil release agent can have a high soil release property and prevent the infiltration of an oily soil.

Another monomer, particularly a fluorine-free monomer, may be introduced into the copolymer of the soil release agent in order to improve the durability of the soil release property, and in order to impart, to the copolymer, solubility in an organic solvent and adhesion to a softness-imparted textile.

Specific examples of such another monomer include, but not limited to, diacetone acrylamide, (meth)acrylamide, N-methylolacrylamide, hydroxyethyl(meth)acrylate, 3-chloro-2-hydroxypropyl(meth)acrylate, N,N-dimethylaminoethyl (meth)acrylate, N,N-diethylaminoethyl(meth)acrylate, butadiene, chloroprene, glycidyl(meth)acrylate, derivatives of maleic acid, halogenated vinyls such as vinyl chloride, ethylene, halogenated vinylidenes such as vinylidene chloride, vinyl alkyl ether, glycerol (meth)acrylate, styrene, acetoacetoxyethyl(meth)acrylate, alkyl(meth)acrylate, vinyl pyrrolidone, isocyanate group-containing (meth)acrylate such as 2-isocyanatoethyl methacrylate or (meth)acrylate thereof in which the isocyanate group is blocked with a blocking agent such as methyl ethyl ketoxime.

The copolymerization ratio of such another monomer is 0 to 40% by weight, preferably 0 to 30% by weight, for example, 0.1 to 20% by weight, based on the weight of the copolymer. Such another monomer may be a mixture of 2 or more different monomers.

The weight-average molecular weight of the copolymer of the soil release agent may be 1,000 to 1,000,000, preferably 5,000 to 500,000, determined by gel permeation chromatography, in terms of polystyrene.

The copolymer of the soil release agent may be a random copolymer or a block copolymer.

The polymerization methods for obtaining the copolymer of the water- and oil-repellent agent and the copolymer of the soil release agent are not limited, and may be selected from various polymerization methods such as bulk polymerization, solution polymerization, emulsion polymerization and radiation polymerization. In general, for example, solution polymerization using an organic solvent or emulsion polymerization using water, or an organic solvent and water in combination is employed. The resultant copolymer is diluted with water or is emulsified in water in the presence of an emulsifier to thereby prepare a treatment agent.

Examples of the organic solvent include ketones such as acetone and methyl ethyl ketone; esters such as ethyl acetate and methyl acetate; glycols such as propylene glycol, dipropylene glycol monomethyl ether, dipropylene glycol, tripropylene glycol and low molecular weight polyethylene glycol; and alcohols such as ethyl alcohol and isopropanol.

As the emulsifier for use in emulsifying the copolymer in water in the emulsion polymerization or after the polymerization, ordinary anionic, cationic or nonionic emulsifiers can be used.

As a polymerization initiator, there can be used, for example, peroxides, azo compounds or persulfuric acid compounds. The polymerization initiator is generally water-soluble and/or oil soluble.

Specific examples of the oil soluble polymerization initiator include, preferably, 2,2′-azobis(2-methylpropionitrile), 2,2′-azobis(2-methylbutylonitrile), 2,2′-azobis(2,4-dimethylvaleronitrile), 2,2′-azobis(2,4-dimethyl-4-methoxyvaleronitrile), 1,1′-azobis(cyclohexane-1-carbonitrile), dimethyl-2,2′-azobis(2-methylpropionate), 2,2′-azobis(2-isobutylonitrile), benzoyl peroxide, di-tertiary-butyl peroxide, lauryl peroxide, cumene hydroperoxide, t-butylperoxy pivalate, diisopropylperoxy dicarbonate and t-butyl perpivalate.

Specific examples of the water-soluble polymerization initiator include, preferably, 2,2′-azobisisobutylamidine dihydrochloride, 2,2′-azobis(2-methylpropionamidine) hydrochloride, 2,2′-azobis[2-(2-imidazoline-2-yl)propane]hydrochloride, 2,2′-azobis[2-(2-imidazoline-2-yl)propane]sulfate hydrate, 2,2′-azibis[2-(5-methyl-2-imidazoline-2-yl)propane]hydrochloride, potassium persulfate, barium persulfate, ammonium persulfate and hydrogen peroxide.

The polymerization initiator is used in an amount of 0.01 to 5 parts by weight per 100 parts by weight of the monomers. A known mercapto group-containing compound further may be used in order to adjust the molecular weight of the copolymer. Examples of such a compound include 2-mercaptoethanol, thiopropionic acid, and alkyl mercaptan. The mercapto group-containing compound is used in an amount of 5 parts by weight or less, for example, 0.01 to 3 parts by weight per 100 parts by weight of the monomers.

Specifically, the copolymer is produced as follows.

In the solution polymerization, the monomers are dissolved in an organic solvent in the presence of a polymerization initiator. After the displacement of an inner atmosphere with a nitrogen gas, the resulting solution is stirred under heating at a temperature of, for example, 50 to 120° C. for 1 to 10 hours. In general, the polymerization initiator may be an oil soluble polymerization initiator. The organic solvent to be used is inactive with the monomers and dissolves them. Examples of such an organic solvent include pentane, hexane, heptane, octane, cyclohexane, benzene, toluene, xylene, petroleum ether, tetrahydrofuran, 1,4-dioxane, methyl ethyl ketone, methyl isobutyl ketone, ethyl acetate, butyl acetate, 1,1,2,2-tetrachloroethane, 1,1,1-trichloroethane, trichloroethylene, perchloroethylene, tetrachlorodifluoroethane and trichlorotrifluoroethane. The organic solvent is used in an amount of 50 to 1,000 parts by weight per total 100 parts by weight of the monomers.

In the emulsion polymerization, the monomers are emulsified in water in the presence of a polymerization initiator and an emulsifier. After the displacement of an inner atmosphere with a nitrogen gas, the resulting emulsion is stirred at a temperature of, for example, 50 to 80° C. for 1 to 10 hours for the copolymerization thereof. The polymerization initiator may be a water-soluble polymerization initiator and/or an oil soluble polymerization initiator. To obtain an aqueous dispersion of the copolymer excellent in standing stability, it is desirable to use an emulsifying apparatus capable of exhibiting a powerful grinding energy, such as a high pressure homogenizer and ultrasonic homogenizer to grind the monomers into very fine particles, which are then polymerized in the presence of a water-soluble polymerization initiator. The emulsifier may be selected from various emulsifiers such as cationic, anionic and nonionic emulsifiers for use. The emulsifier is used in an amount of 0.5 to 10 parts by weight per 100 parts by weight of the monomers. When the monomers are not completely dissolved into each other, preferably, an agent for imparting sufficient compatibility to the monomers, for example, a water-soluble organic solvent or a low molecular weight monomer, is added to the monomers. The addition of such an agent makes it possible to facilitate the emulsion and copolymerization of the monomers.

Examples of the water-soluble organic solvent include acetone, methyl ethyl ketone, propylene glycol, dipropylene glycol monomethyl ether, dipropylene glycol, tripropylene glycol, and ethanol. This solvent may be used in an amount of 1 to 80 parts by weight, for example, 5 to 50 parts by weight, per 100 parts by weight of water.

Each of the copolymers for both agents, thus obtained, is optionally diluted with or dispersed in, for example, water, an organic solvent, and the resulting solution or dispersion is prepared into a desired form such as an emulsion thereof, a solution thereof in an organic solvent and an aerosol thereof, which can be used as a water- and oil-repellent agent or a soil release agent. The respective copolymers act as active components of the water- and oil-repellent agent and the soil release agent. The water- and oil-repellent agent and the soil release agent comprise the fluoro-copolymers and media (particularly liquid media) (e.g., organic solvents and/or water), respectively. The concentrations of the fluoro-copolymers in the water- and oil-repellent agent and the soil release agent may be 0.01 to 50% by weight, for example, 0.05 to 10% by weight, respectively.

In the present invention, the water- and oil-repellent agent and the soil release agent preferably contain the fluoro-copolymers and aqueous media, respectively. The term, “aqueous medium” herein referred to means a medium consisting of water, and it also means a medium containing an organic solvent in addition to water (the amount of the organic solvent being 80 parts by weight or less, for example, 5 to 50 parts by weight, per 100 parts by weight of water).

A method for printing the water- and oil-repellent agent on a textile, using a generally industrialized printing machine, can be employed in order to locate the water- and oil-repellent agent in the dot pattern or the lattice pattern on the textile while the diameters of the located dots or the stripe width of the located lattice being controlled to 10 to 1,500 μm with the intervals between the dots or between the stripes of the lattice controlled to 10 to 1,500 μm, so that the soil release agent is located on remainder portions of the textile. In this method, as the case may be, it is needed to prepare a treatment liquid of which the viscosity is appropriately adjusted, in order to prevent the bleeding of the agent from the printed pattern. Thus, a treatment liquid viscosity-adjusting agent can be added to the treatment liquid. As such a viscosity-adjusting agent, for example, acrylic polymer salts which are commercially available as sizing agents, can be used. As the commercially available sizing agent, for example, CARBOPOL 846 (manufactured by Goodrich Corporation) can be used. The viscosity-adjusting agent for the treatment liquid is not necessarily removed by washing after the treatment of the textile. If needed, the treatment liquid may optionally contain other agents such as a crease-proofing agent, a shrink-proofing agent, a flame retardant, a crosslinking agent, an antistatic agent, a softening agent and an antibacterial agent.

The method for printing the water- and oil-repellent agent on a textile, using a generally industrialized printing machine, can be employed in order to locate the water- and oil-repellent agent dot-pattern or lattice-pattern on the textile. As the printing method, for example, a roller printing, a screen printing and an ink-jet printing can be exemplified.

Preferably, the diameters of the dots or the widths of the stripes of the lattice formed from the water- and oil-repellent agent on the textile are controlled to 10 to 1,500 μm, and the intervals between each of the dots or between each of the stripes of the lattice are controlled to 10 to 1,500 μm. More preferably, the diameters of the dots or the widths of the stripes of the lattice and the intervals between each of the dots or between each of the stripes of the lattice are both 20 to 1,200 μm. When the pattern of the dots or the lattice is too dense, the advanced technique and skill are needed for the treatment of the textile, which is likely to make it impossible to treat the textile, and which is also unlikely to make significant difference from a flat treatment and makes it impossible to achieve the object of the present invention. When the pattern of the dots or the stripes of the lattice is too sparse, water droplets and oil droplets easily infiltrate the intervals between each of the dots or between each of the stripes of the lattice, with the result that the water- and oil-repellency of the textile tends to lower.

To locate the soil release agent on remainder portions of the textile, there can be employed the above-mentioned printing method using the printing machine or a method of padding the textile by a generally industrialized padding machine. In case of the printing with the printing machine, a viscosity-adjusting agent may be added to a treatment liquid. The viscosity-adjusting agent may not necessarily be removed by washing after the treatment. If needed, other agents may be further added to the treatment liquid. Examples of the other agents include a crease-proofing agent, a shrink-proofing agent, a flame retardant, a crosslinking agent, a antistatic agent, a softening agent and antibacterial agent.

The predetermined pattern located on the textile is obtained by two treatment steps, that is, the treatment with the water- and oil-repellent agent followed by the treatment with the soil release agent, or the treatment with the soil release agent followed by the treatment with the water- and oil-repellent agent. The treatment order is not particularly limited. If needed, a heat treatment may be carried out after each of the treatment steps. The heat treatment may be carried out at a temperature of 80 to 200° C. for 10 to 300 seconds.

The textile is preferably in the form of a cloth such as a woven cloth, a knitted cloth and a non-woven cloth. The cloth may, for example, be a carpet. Fibers for the textile are, for example, natural animal and vegetable fibers such as cotton, hemp, wool and silk; synthetic fibers such as polyamide, polyester, polyvinyl alcohol, polyacrylonitrile, polyvinyl chloride and polypropylene; semisynthetic fibers such as rayon and acetate; inorganic fibers such glass fibers, carbon fibers and asbestos fibers; and a blend of said fibers.

The present invention is described with reference to the accompanying drawings.

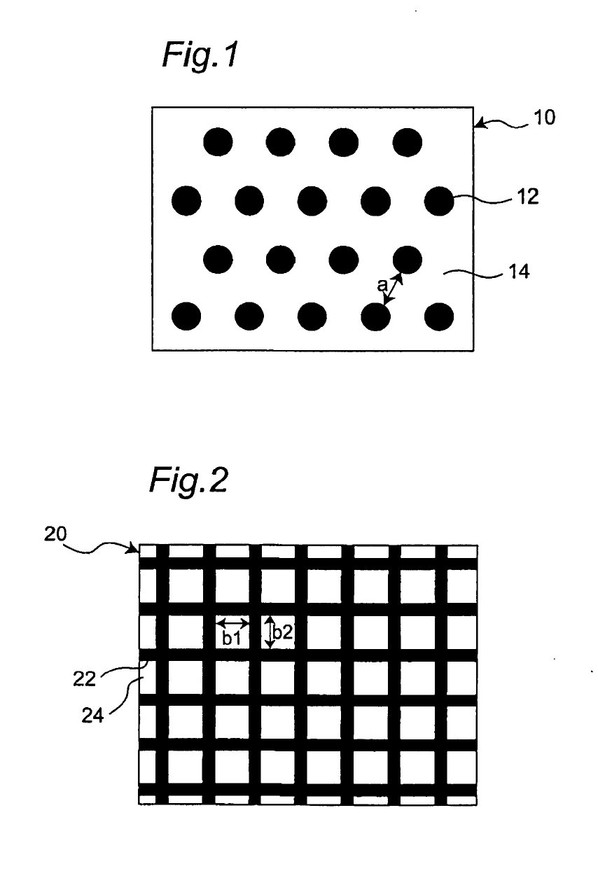

FIG. 1 shows a cloth on which the water- and oil-repellent agent is located in a dot pattern (a circular dot pattern) so that the soil release agent is located on remainder portion of the cloth. The cloth 10 (cloth as a whole) has a region 12 coated with the water- and oil-repellent agent and a remainder region 14 coated with the soil release agent. In the water- and oil-repellent agent-located region 12, the active component of the water- and oil-repellent agent is exposed on the surface of the cloth. In the soil release agent-located region 14, the active component of the soil release agent is exposed on the surface of the cloth. In the water- and oil-repellent agent-located region 12, the dots of the agent are positioned at the interval a.

FIG. 2 shows cloth on which the water- and oil-repellent agent is located in a lattice-pattern so that the soil release agent is located on remainder portions of the cloth. The cloth 20 (cloth as a whole) has a region 22 coated with the water- and oil-repellent agent and the remainder regions 24 coated with the soil release agent. The water- and oil-repellent agent-located region 22 is in the shape of lattice. In this lattice, the widths of the vertical lines are preferably equal to the widths of the horizontal lines, although the widths of both the lines may differ from each other. Both the lines of the lattice are spaced at intervals b1 and b2, respectively. The length of the interval b1 is preferably equal to the length of the interval b2, although the lengths of both the intervals may differ from each other.

### EXAMPLES

Next, the present invention will be described in more detail by way of Synthesis Examples, Examples and Comparative Examples, which should not be construed as limiting the scope of the present invention in any way. In Synthesis Examples, Examples and Comparative Examples, “%” represents “% by weight”, unless otherwise specified.

The tests were conducted as follows.

Water-Repellency Test

A water-repellency test was conducted on a textile according to the spraying method regulated in JIS-L-1092. Water repellency was represented by the repellency No. in accordance with the spraying method of JIS-L-1092 (shown in Table 1).

TABLE 1
Criteria for Repellency

| Repellency | |
|---|---|
| No. | Condition |
| 5 | No wetting on surface |
| 4 | Slight wetting on surface |
| 3 | Partial wetting on surface |
| 2 | Wetting on surface |
| 1 | Wetting on surface as whole |
| 0 | Wetting on front and back surfaces as whole |

Oil-Repellency Test

An oil-repellency test was conducted on a textile according to AATCC-TM118-2000 (American Association of Textile Chemists and Colorists-Test Method 118-2000).

Summary of Oil-Repellency Test Procedure

A treated cloth test was stored in a thermo-hygrostat at a temperature of 21° C. and a humidity of 65% for 4 hours or longer. A test liquid (shown in Table 2) also maintained at a temperature of 21° C. was used. The test was conducted in an air-conditioned room at a temperature of 21° C. and a humidity of 65%. The test liquid (0.05 ml) was gently dropped on the cloth and was left to stand for 30 seconds. The test liquid was regarded as passing the test, when the droplets of the test liquid are left to remain on the cloth. The oil repellency was evaluated in nine levels of 0, 1, 2, 3, 4, 5, 6, 7 and 8, in the order of from the lowest level to the highest level, based on the highest mark of a test liquid which has passed the test.

TABLE 2
Oil Repellency Criteria

| | | Surface Tension |
|---|---|---|
| Marks | Test liquid | (dyne/cm at 25° C.) |
| 8 | n-Heptane | 20 |
| 7 | n-Octane | 21.8 |
| 6 | n-Decane | 23.5 |
| 5 | n-Dodecane | 25 |
| 4 | n-Tetradecane | 26.7 |
| 3 | n-Hexadecane | 27.3 |
| 2 | Mixed liquid of n-hexadecane | 29.6 |
| | 35/Nujol 65 | |
| 1 | n-Nujol | 31.2 |
| 0 | inferior to 1 | — |

Soil Release (SR) Test

A test for evaluating a soil releasability (SR) was conducted on a similar textile to that used for the oil repellency test, in an air conditioned room according to AATCC Stain Release Management Performance test Method. As soils for test, used were an oily soil prepared by adding DAPHNE Mechanic Oil (manufactured by IDEMITSU KOSAN CO., LTD.) (100 ml) to a paste (1 g) consisting of carbon black (16.7%), a beef tallow extremely hardened oil (20.8%) and liquid paraffin (62.5%), and an aqueous soil consisting of UNI-STAMP INK (manufactured by MITSUBISHI PENCIL CO., LTD.).

Summary of Soil Release Test Procedure

A square test cloth (20 cm×20 cm) was spread over a blotting paper laid horizontally, and 5 drops of the soil (about 0.2 cc) was allowed to blot the test cloth. A glassine paper was laid over the test cloth, and a weight (2,268 g) was further laid on the glassine paper. This state was maintained for 60 seconds. Thereafter, the weight and the glassine paper were removed, and then, the test cloth was left to stand at a room temperature for 15 minutes. Thereafter, ballast cloths were added to the test cloth so that the total weight could be 1.8 kg. The test cloth and the ballast cloth were washed at a bath temperature of 38° C. for 12 minutes in an AATCC standard washing machine with a capacity of 64 L (manufactured by Kenmore, U.S.A.), using a detergent (a WOB detergent of AATCC standard). Thereafter, the test cloth was dried in a tumbler drier of AATCC standard (manufactured by Kenmore, U.S.A.). The conditions of the remaining soils on the dried test cloth were compared with standard photographic plates so as to determine a corresponding criterion which indicates the soil release performance (shown in Table 3). The standard photographic plates used for evaluation were in accordance with AATCC-TM 130-2000 (American Association of Textile Chemists and Colorists—Test Method 130-2000).

TABLE 3
Criteria for Soil releasability

| Level | Criteria |
|---|---|
| 1 | Soils remarkably remain |
| 2 | Soils considerably remain |
| 3 | Soils slightly remain |
| 4 | Little soils remain |
| 5 | No soil remains |

Test for Evaluating Feeling

A test for evaluating the feeling of a textile was conducted on a test cloth by hand feeling, and the feeling of the test cloth was evaluated based on the following criteria.

Feeling comparable to non-treated cloth: Good

Feeling slightly harder than non-treated cloth: Fair

Feeling apparently harder than non-treated cloth: Bad

### Synthesis Example 1

A water- and oil-repellent agent was prepared as follows.

A 1 L beaker was charged with a fluorine-containing monomer (90 g) of the formula:
H₂C═CHCOO—CH₂CH₂—(CF₂CF₂)₃CF₂CF₃,
n-stearyl acrylate (10 g), N-methylolacrylamide (3 g), n-lauryl mercaptan (1 g), tripropylene glycol (40 g), polyoxyethylene (3 mol)dodecyl ether (4 g), polyoxyethylene (20 mol)lauryl ether (9 g) and pure water (250 g). The mixture in the beaker was emulsified and dispersed at 50° C. in a high pressure homogenizer until the average particle sizes of the emulsion reached 150 nm or less. Next, a whole volume of the emulsion was transferred to a 1 L autoclave equipped with a stirrer. After the inner atmosphere of the autoclave was replaced with a nitrogen gas, vinyl chloride (24 g) and azobisamidinopropane dihydrochloride (1 g) were added into the autoclave, so as to react them at 60° C. for 8 hours under seal. The resultant polymerization liquid was directly subjected to gel permeation chromatography to measure the molecular weight. As a result, it was confirmed that the peaks derived from the monomers substantially disappeared, and that peaks derived from a copolymer appeared. The weight-average molecular weight of the copolymer was 50,000 (in terms of polystyrene). The constituents of the copolymer were substantially equal to the composition of the charged monomers. The resultant polymerization liquid was diluted with pure water to obtain a water- and oil-repellent liquid having a copolymer concentration of 30%.

### Synthesis Example 2

A soil release agent was prepared as follows.

A 1 L four-necked flask equipped with a stirrer was charged with a fluorine-containing monomer (60 g) of the formula:
H₂C═CHCOO—CH₂CH₂—(CF₂CF₂)₃CF₂CF₃,
methoxypolyethyleneglycol methacrylate (EO 9 mol) (30 g), 2-hydroxyethyl methacrylate (8 g), 2-methacryloyloxyethyl-trimethylammonium chloride (2 g), 2-mercaptoethanol (0.2 g) and isopropyl alcohol (250 g), and a nitrogen gas was allowed to flow into the flask for 60 minutes. The internal temperature of the flask was raised to 75 to 80° C., and azobisisobutyronitrile (1 g) was added. The mixture was reacted for 8 hours, and the resultant polymerization liquid was directly subjected to gel permeation chromatography so as to measure the molecular weight thereof. As a result, it was confirmed that the peaks derived from the monomers substantially disappeared, and that peaks derived from a copolymer appeared. The weight-average molecular weight of the copolymer was 11,000 (in terms of polystyrene). The constituents of the copolymer were substantially equal to the composition of the charged monomers. The resultant polymerization liquid was diluted with pure water to obtain a soil release liquid having a copolymer concentration of 20%.

### Synthesis Example 3

The same operation as in Synthesis Example 2 was repeated to obtain a polymerization liquid, except that a fluorine-containing monomer of the formula:
H₂C═CHCOO—CH₂CH₂CH₂—SO₂—C₄F₉,
was used instead of the fluorine-containing monomer of the formula used in Synthesis Example 2:
H₂C═CHCOO—CH₂CH₂—(CF₂CF₂)₃CF₂CF₃.
The resultant polymerization liquid was directly subjected to gel permeation chromatography so as to measure the molecular weight thereof. As a result, it was confirmed that the peaks derived from the monomers substantially disappeared, and that peaks derived from a copolymer appeared. The weight-average molecular weight of the copolymer was 11,000 (in terms of polystyrene). The constituents of the copolymer were substantially equal to the composition of the charged monomers. The resultant polymerization liquid was diluted with pure water to obtain a soil release liquid having a copolymer concentration of 20%.

### Example 1

The soil release agent (18 g) of Synthesis Example 2 was diluted with tap water to prepare a diluted liquid (300 g). A white blended yarn cloth of polyester and cotton (hereinafter referred to as “PET/cotton blended white cloth”) was dipped in the diluted liquid and was then squeezed with a mangle to thereby pad the cloth with the diluted liquid. In this step, the mangle squeezing rate was controlled to adjust the adhering ratio of active component in the soil release agent, to 1.0 mass % relative to the cloth. Next, the water- and oil-repellent agent (15 g) of Synthesis Example 1 and a sizing agent (45 g) (CARBOPOL 846 manufactured by Goodrich Corporation) were diluted with tap water to give a liquid (100 g). This water- and oil-repellent formulation liquid was printed in a dot pattern on the cloth under a wet state by a screen printing machine, so that dots having the diameter of 500 μm were located at intervals of 700 μm among each of the dots, and so that the adhering ratio of active component in the water- and oil-repellent agent was 1.0 mass % relative to the cloth. The printed cloth was further subjected to heat treatment at 170° C. for 60 seconds to thereby prepare a cloth for use in evaluation. The water repellency, oil repellency, soil releasability and feeling of the cloth were evaluated. The results are shown in Table 4 below.

### Example 2

The same operation as in Example 1 was repeated, except that, instead of the padding treatment using the soil release agent in Example 1, a liquid (100 g) prepared by diluting the soil release agent (20 g) of Synthesis Example 2 and the sizing agent (CARBOPOL 846 manufactured by Goodrich Corporation) (45 g) with tap water was printed on the whole surface of the cloth by a screen printing machine in the first treatment step, so that the adhering ratio of active component in the soil release agent could be 1.0 mass % relative to the cloth. The results are shown in Table 4.

### Example 3

The same operation as in Example 1 was repeated, except that the order of the padding treatment using the soil release agent and the printing treatment using the water- and oil-repellent agent in Example 1 was reversed, and that the cloth treated by the printing of the water- and oil-repellent agent was additionally subjected to heat treatment at 170° C. for 60 seconds in order to prevent the removal of the water- and oil-repellent agent in a padding bath of the soil release agent. The results are shown in Table 4.

### Example 4

The same operation as in Example 2 was repeated, except that the order of the printing treatment using the soil release agent and the printing treatment using the water- and oil-repellent agent in Example 2 was reversed. The results are shown in Table 4.

### Example 5

The same operation as in Example 1 was repeated, except that, instead of the dot printing treatment using the water- and oil-repellent agent in Example 1, the water- and oil-repellent agent was printed in a lattice pattern on the cloth with the widths of the stripes of the lattice adjusted to 500 μm and the interval between each of the stripes, to 700 μm. The results are shown in Table 4.

### Example 6

The same operation as in Example 1 was repeated, except that the soil release agent of Synthesis Example 3 was used instead of the soil release agent of Synthesis Example 2 used in Example 1. The results are shown in Table 4.

### Comparative Example 1

The water- and oil-repellent agent (12 g) of Synthesis Example 1 was diluted with tap water to obtain a diluted liquid (300 g). A white PET/cotton blended yarn cloth was dipped in this liquid and was then squeezed with a mangle, so that the cloth was padded. The mangle squeezing rate was controlled to adjust the adhering ratio of active component in the water- and oil-repellent agent, to 1.0 mass % relative to the cloth. The cloth was further subjected to heat treatment at 170° C. for 60 seconds to obtain a cloth for evaluation. The water repellency, oil repellency, soil releasability and feeling of the cloth were evaluated. The results are shown in Table 4.

### Comparative Example 2

The same operation as in Comparative Example 1 was repeated, except that the soil release agent (18 g) of Synthesis Example 2 was used instead of the water- and oil-repellent agent (12 g) of Synthesis Example 1. The results are shown in Table 4.

### Comparative Example 3

The same operation as in Example 1 was repeated, except that the padding treatment using the soil release agent was not done. The results are shown in Table 4.

### Comparative Example 4

A mixture of the water- and oil-repellent agent (12 g) of Synthesis Example 1 and the soil release agent (18 g) of Synthesis Example 2 was diluted with tap water to obtain a liquid (300 g). A white PET/cotton blended yarn cloth was dipped in the liquid of the agents and was then squeezed with a mangle, so that the cloth was padded with the agents. The mangle squeezing rate was controlled to adjust the adhering ratios of the active components of the water- and oil-repellent agent and the soil release agent to 1.0 mass %, respectively, relative to the cloth. The cloth was further subjected to heat treatment at 170° C. for 60 seconds to obtain a cloth for evaluation. The water repellency, oil repellency, soil releasability and feeling of the cloth were evaluated. The results are shown in Table 4.

### Comparative Example 5

A mixture of the water- and oil-repellent agent (15 g) of Synthesis Example 1, the soil release agent (20 g) of Synthesis Example 2 and a sizing agent (CARBOPOL 846) (45 g) was diluted with tap water to obtain a liquid (100 g), which was then printed on the whole surface of a cloth, using a screen printing machine, so that the adhering ratio of each active components, i.e., each of the water- and oil-repellent agent and the soil release agent relative to the cloth could be 1.0 mass %, respectively. The cloth was further subjected to heat treatment at 170° C. for 60 seconds to obtain a cloth for evaluation. The water repellency, oil repellency, soil releasability and feeling of the cloth were evaluated. The results are shown in Table 4.

### Comparative Example 6

The same operation as in Comparative Example 1 was repeated, except that the soil release agent (18 g) of Synthesis Example 3 was used instead of the water- and oil-repellent agent (12 g) of Synthesis Example 1. The results are shown in Table 4.

TABLE 4
Test Results

| | | | | | | | Soil | | |
|---|---|---|---|---|---|---|---|---|---|
| | | | | | | | releasability | | |
| | Type and method of treatment | | | | Water | Oil | Oily | Aqueous | |
| | First step | | Second step | | repellency | repellency | soil | soil | |
| | Type | Method | Type | Method | (mark) | (mark) | (mark) | (mark) | Feeling |
| Ex. 1 | Soil | Padding | Water- | Dot | 5 | 6 | 4 | 3 | Good |
| | releasing | | & oil- | printing | | | | | |
| | | | repelling | | | | | | |
| Ex. 2 | Soil | Printing | Water- | Dot | 5 | 6 | 4 | 3 | Good |
| | releasing | on whole | & oil- | printing | | | | | |
| | | surface | repelling | | | | | | |
| Ex. 3 | Water- & | Dot | Soil | Padding | 5 | 6 | 4 | 3 | Good |
| | oil- | printing | releasing | | | | | | |
| | repelling | | | | | | | | |
| Ex. 4 | Water- & | Dot | Soil | Printing | 5 | 6 | 4 | 3 | Good |
| | oil- | printing | releasing | on | | | | | |
| | repelling | | | whole | | | | | |
| | | | | surface | | | | | |
| Ex. 5 | Soil | Padding | Water- | Lattice | 5 | 6 | 4 | 3 | Good |
| | releasing | | & oil- | printing | | | | | |
| | | | repelling | | | | | | |
| Ex. 6 | Soil | Padding | Water- | Dot | 5 | 6 | 4 | 3 | Good |
| | releasing | | & oil- | printing | | | | | |
| | | | repelling | | | | | | |
| Blank* | — | — | — | — | 0 | 0 | 2 | 2 | Good |
| C. Ex. 1 | Water- & | Padding | — | — | 5 | 6 | 1 | 1 | Bad |
| | oil- | | | | | | | | |
| | repelling | | | | | | | | |
| C. Ex. 2 | Soil | Padding | — | — | 2 | 5 | 4 | 3 | Good |
| | releasing | | | | | | | | |
| C. Ex. 3 | Water- & | Dot | — | — | 1 | 1 | 1 | 1 | Good |
| | oil- | printing | | | | | | | |
| | repelling | | | | | | | | |
| C. Ex. 4 | Water- & | Padding | — | — | 3 | 6 | 2 | 1 | Fair |
| | oil- | | | | | | | | |
| | repelling | | | | | | | | |
| | and | | | | | | | | |
| | Soil | | | | | | | | |
| | releasing | | | | | | | | |
| C. Ex. 5 | Water- & | Printing | — | — | 3 | 6 | 2 | 1 | Fair |
| | oil- | on whole | | | | | | | |
| | repelling | surface | | | | | | | |
| | and | | | | | | | | |
| | Soil | | | | | | | | |
| | releasing | | | | | | | | |
| C. Ex. 6 | Soil | Padding | — | — | 1 | 5 | 4 | 3 | Good |
| | releasing | | | | | | | | |

*Blank indicates a non-treated cloth

It is known from the results shown in Table 4 that the inherent effects of the water- and oil-repellent agents and the soil release agents can be retained and compatibly exhibited, and also can impart to the textiles such properties that soils are hardly adhered and easily removed, and additionally the feeling of the textiles can be prevented from degrading.

1. A textile which has a main surface consisting of a surface having an exposed water- and oil-repellent agent and a surface having an exposed soil release agent, by applying both the water- and oil-repellent agent and the soil release agent to the main surface,
characterized in that, in any of square surface regions, of the main surface of the textile, having a side length of 3,000 μm, a ratio A of the area of the surface having the exposed water- and oil-repellent agent is from 10 to 90%, and a ratio B of the area of the surface having the exposed soil release agent is from 90 to 10%, provided that the total of the ratios A and B is 100%.

2. The textile according to claim 1, wherein the ratio A is from 18 to 82%, and the ratio B is from 82 to 18%.

3. The textile according to claim 1, wherein the surface having the exposed water- and oil-repellent agent is in the shape of a dot, particularly a circular dot, or in the shape of a lattice, and the remainder surface is the surface having the exposed soil release agent.

4. The textile according to claim 3, wherein the diameter of each of the dots or the width of each of the stripes of the lattice is from 10 to 1,500 μm, and the distance between the dots or between the stripes of the lattice is from 10 to 1,500 μm.

5. The textile according to claim 1, wherein the water- and oil-repellent agent is a fluorine-containing water- and oil-repellent agent or a silicon-containing water- and oil-repellent agent, and the soil release agent is a fluorine-containing soil release agent or a phospholipid-containing soil release agent.

6. The textile according to claim 1, wherein a polymer constituting the water- and oil-repellent agent is a copolymer which comprises a silicone-based monomer or a fluorine-containing monomer and a copolymerizable non-hydrophilic silicon-free fluorine-free monomer, while a polymer constituting the soil release agent is a polymer which comprises a hydrophilic phosphorus-free fluorine-free monomer.

7. The textile according to claim 1, wherein the polymer constituting the soil release agent contains a fluorine-containing monomer.

8. A kit comprising a water- and oil-repellent agent and a soil release agent for use in the manufacturing of the textile defined in claim 1.

9. A method for manufacturing the textile defined in claim 1, comprising a step of padding or printing a soil release agent on the textile before or after a step of printing of a water- and oil-repellent agent.
